(19) United States
(12) Patent Application Publication
(10) Pub. No.: US 2012/0240383 A1
(43) Pub. Date: Sep. 27, 2012

(54) PRODUCTION METHOD OF FORMING MOLD

(75) Inventors: Kimihisa KANEKO, Nagoya-City (JP); Kunihiko YOSHIOKA, Nagoya-City (JP)

(73) Assignee: NGK Insulators, Ltd., Nagoya-City (JP)

(21) Appl. No.: 13/409,328

(22) Filed: Mar. 1, 2012

(30) Foreign Application Priority Data
Mar. 22, 2011 (JP) 2011-061908

(51) Int. Cl. B23P 17/04

(52) U.S. Cl. 29/527.1

(57) ABSTRACT

A forming mold having a base member 10, and a resin layer 20 formed on the base member 10. The base member 10 has a rigidity higher than that of the resin layer 20. On the surface of the base member 10, the resin layer 20 having a thickness (Tb) of 1 mm or more is formed through lining or a similar technique. Then, the surface of the portion of the resin layer 20, the portion to be serve as a forming surface, is machined (e.g., end-milled) for finishing so that the thickness of the portion is reduced from Tb to Ta, whereby a forming surface P1 is completed. The forming surface P1 has a form accuracy as high as that attained by a forming surface of a forming mold produced through machining without employing a resin layer.

### FIELD OF THE INVENTION

The present invention relates to a method for producing a forming mold employed in yielding a molded product.

### DESCRIPTION OF THE RELATED ART

Typically, molded products such as urethane molded products are produced by means of a forming mold through the following sequential steps. Firstly, a precursor of a molded product (e.g., a slurry) is poured into a space for forming a material (hereinafter referred to as a forming space) defined by a surface provided for forming an object material (hereinafter referred to as a forming surface) of the forming mold. As used herein, the term “forming surface” refers to a surface which is a surface in direct contact with a molded product precursor (slurry, paste, etc.) cast into the molding space. Then, the slurry or the like is solidified (and dried), to thereby provide a molded product in the forming space. The forming mold is removed from the molded product (i.e., the molded product is released from the forming mold), to thereby separate the molded product.

During mold releasing, in some cases, a molded product adheres on the forming surface of the forming mold. In order to prevent adhesion of a molded product (i.e., to enhance mold-releasability), a fluororesin layer is provided on the forming surface of a forming mold. This technique is widely known in the art (see, for example, Patent Document 1).

For example, Japanese Patent Application Laid-Open (kokai) No. 2006-264225 discloses that an Ni-containing under-plating layer is formed on the forming surface of a forming mold, and the under-plating layer is coated with a fluororesin layer (thickness: ≦50μ). Patent Document 1 also discloses that the hardness of the forming surface of the forming mold is ensured by means of the under-plating layer formed through the treatment, and the fluororesin layer provides excellent mold-releasability.

### SUMMARY OF THE INVENTION

Meanwhile, in the forming mold disclosed in the above document, the surface of the formed fluororesin layer provides a “forming surface.” Generally, the surface of a layer formed through a coating process has poor form accuracy (e.g., surface roughness, flatness, or degree of parallelization). Therefore, the forming surface of the forming mold disclosed in the above document has also poor form accuracy.

The present invention has been conceived in order to solve the problem. Thus, an object of the present invention is to provide a method for producing a forming mold which has a resin layer serving as a forming surface, the resin layer having high form accuracy.

Accordingly, the forming mold produced through the production method of the present invention comprises a base member, and a resin layer which is formed on the base member and which serves as a forming surface. The base member has a rigidity higher than that of the resin layer. As used herein, the term “rigidity” refers to a product (EI) of Young's modulus of material E [N/m²] and cross-section secondary moment I along the depth direction [m⁴]. In one embodiment of the present invention, the resin layer is formed of a fluorine compound, and the base member is formed of a metal.

According to the method of the present invention for producing a forming mold, a resin layer having a thickness of 1 mm or more is formed on (a surface of) the base member. The resin layer is formed so as to cover the surface of the base member. The resin layer may be formed through, for example, lining, coating, painting (applying), sticking a resin sheet thereon, or a like technique. Particularly, for ensuring a sufficient thickness of the resin layer, lining or sticking a resin sheet thereon is preferably employed.

Then, the surface of the thus-formed resin layer is machined, to thereby form (complete) the aforementioned forming surface. Examples of the machining technique include end-milling and planar grinding. Thereafter, various finishing processes may be additionally performed. In the meantime, the entire surface of the resin layer may serve as a forming surface, or only a part of the resin layer may serve as a forming surface. In any case, the surface of the resin layer serving as a forming surface is formed (completed) through machining.

Through the aforementioned procedure, the forming surface of the forming mold, formed of the resin layer, is completed through machining. Thus, differing from the forming mold disclosed in the above document (i.e., a forming mold in which the surface of the fluororesin layer formed through a coating process serves as a “forming surface”), the thus-obtained forming surface has a form accuracy as high as that attained by a forming surface of a forming mold produced through working without employing a resin layer. In other words, the invention provides a forming mold having a resin layer which serves as a forming surface and which has high surface form accuracy. As a result, even in the case where the shape of the forming surface is difficult to form by the forming mold disclosed in the aforementioned document (e.g., a forming surface is an inner wall of a sufficiently elongated (with a sufficiently high aspect ratio) through-hole), the form accuracy of the entire forming surface can be enhanced.

In addition, according to the forming mold of the invention, the resin layer is formed on the base member having a rigidity higher than that of the resin layer. Therefore, as compared with a forming mold formed of only a resin layer, deformation of the resin layer is prevented, whereby the form accuracy of the forming surface made of the resin layer can be further enhanced. Furthermore, the surface of the resin layer, which surface has a sufficient thickness of “1 mm or more,” is machined, to thereby form a forming surface. Thus, relatively large machining allowance (i.e., the thickness of a portion to be removed through machining) can be ensured. As a result, there can be realized not only a flat forming surface, but also a forming surface formed of an inner wall of a sufficiently elongated (with a sufficiently high aspect ratio) through-hole, or a forming surface of a complex shape (with corners) which surface is difficult to realize by the forming mold disclosed in the aforementioned document.

More specifically, the forming surface formed through the aforementioned machining procedure preferably has a 10-point average roughness (Rz JIS) of 10 μm or less. In addition, the forming surface formed through the aforementioned machining procedure preferably exhibits a contact angle of 60° or more with respect to water. Under these conditions, excellent mold-releasability can be attained.

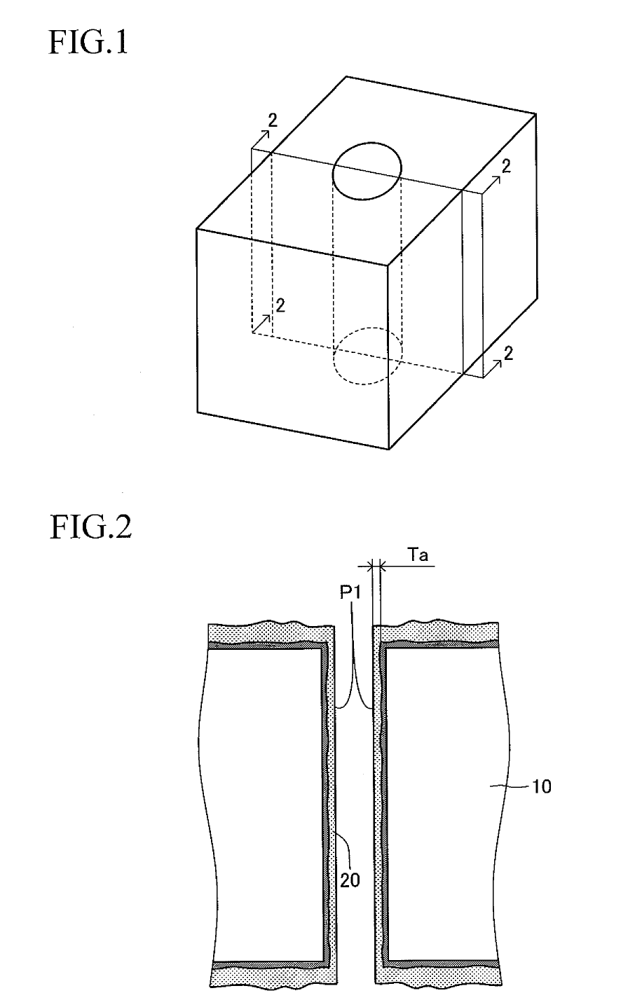

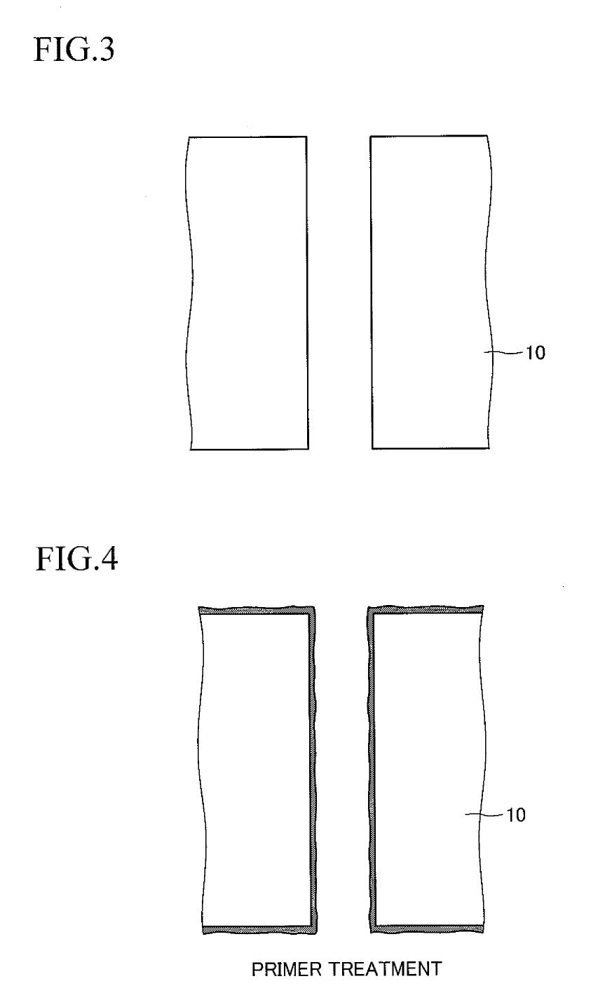

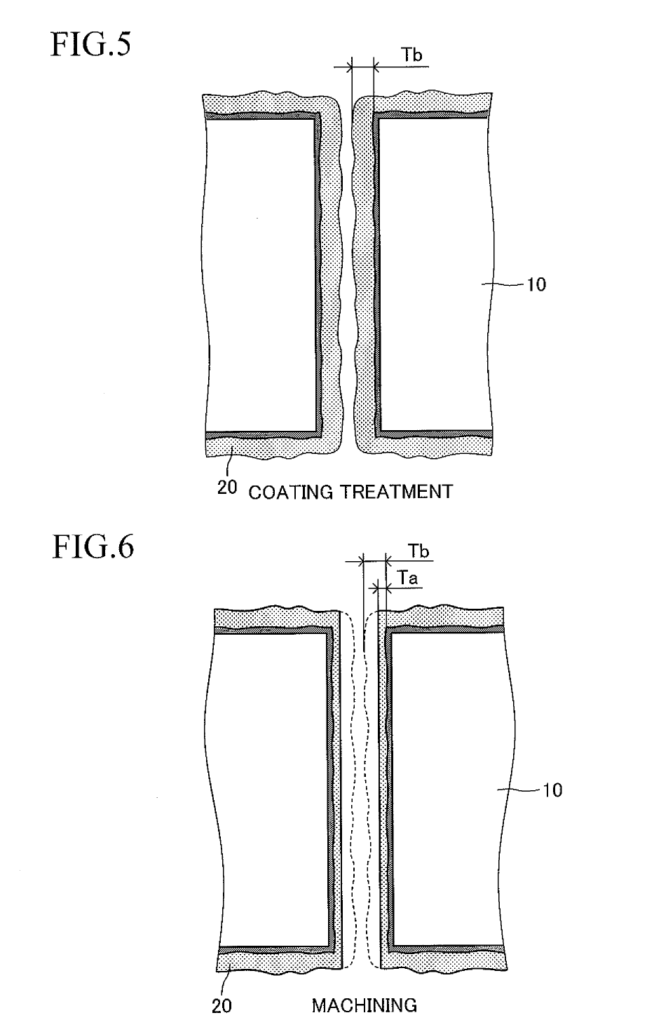

### BRIEF DESCRIPTION OF THE DRAWINGS

[FIG. 1] A perspective view of a forming mold produced through a forming mold production method according to one embodiment of the present invention.

[FIG. 2] A cross-section of the forming mold shown in FIG. 1, cut along the line 2-2.

[FIG. 3] A first step of the production of the forming mold shown in FIG. 1 (corresponding FIG. 2).

[FIG. 4] A second step of the production of the forming mold shown in FIG. 1 (corresponding FIG. 2).

[FIG. 5] A third step of the production of the forming mold shown in FIG. 1 (corresponding FIG. 2).

[FIG. 6] A fourth step of the production of the forming mold shown in FIG. 1 (corresponding FIG. 2).

### MODES FOR CARRYING OUT THE INVENTION

The forming mold produced through the production method of the present invention may be employed as a forming mold for yielding a molded product through a process which includes preparing a slurry from slurry raw materials including a ceramic material powder, a dispersion medium, a gelling agent, and a dispersant; and casting the slurry into the mold. In the forming mold of the present invention, at least a portion of the mold has the characteristic features of the present invention, and preferably the entirety of the forming mold has the characteristic features of the present invention. In the case where the forming mold is composed of a plurality of members such as an upper half and a lower half, at least one member has the characteristic features of the present invention.

### (Configuration)

FIGS. 1 and 2 show an embodiment of the forming mold produced through a forming mold production method according to one embodiment of the present invention. As shown in FIG. 2 (a cross-section of the forming mold shown in FIG. 1, cut along the line 2-2), the forming mold has a base member 10 and a resin layer 20 formed on (covering) the entire surface of the base member 10. In this embodiment, the surface of a portion of the resin layer 20 which portion has been formed on the inner wall of the cylindrical through-hole provided in the base member 10 (i.e., a portion of the resin layer 20 covering the entirety of the base member 10) P1 (i.e., cylinder inner wall surface) serves as a “forming surface.” As used herein, the term “forming surface” refers to a surface which defines the space for providing a molding space for producing a molded product and is a surface in direct contact with a molded product precursor (slurry, paste, etc.) cast into the molding space. In other words, a cylindrical molded produced is yielded by use of the forming mold.

The base member 10 is formed of a metallic material such as aluminum alloy, stainless steel, titanium, or iron-based material. The base member 10 has a rigidity higher than that of the resin layer 20. In other words, the base member 10 can serve as a support base for preventing deformation of the resin layer 20.

The resin layer 20 is formed of a material which provides high mold-releasability, such as fluororesin (fluorine-containing compound), silicone resin (silicone compound), or PVA. Examples of the fluorine-containing compound include PTFE, PFA, ETFE, FEP, PVDF, and PCTFE.

The portion of the resin layer 20 covering the forming surface P1 (i.e., forming a hollow cylinder) has a thickness Ta (see FIG. 2) of 0.1 to 1 mm. As described hereinbelow, the forming surface P1 is completed through machining. The forming surface P1 (i.e., an inner wall surface of the cylinder) has a 10-point average roughness (Rz JIS) of 20 μm or less (preferably 10 μm or less). The forming surface P1 preferably has a contact angle with respect to water of 60° or more (more preferably 85° or more). By virtue of such properties, excellent mold-releasability can be attained. The forming surface P1 is preferably formed from a material containing no additive or primer. However, the inside of the resin layer 20 (a portion not forming the forming surface) may contain an additive or a primer.

### (Production Method)

With reference to FIGS. 3 to 6 (corresponding to FIG. 2), the method for producing a forming mold according to the present invention will be described. As shown in FIG. 3, a base member 10 is produced through a known technique. Then, as shown in FIG. 4, the entire surface of the base member 10 (including the inner wall of the cylindrical through-hole) is treated with a primer through a known technique.

As a result, as shown in FIG. 5, the resin layer 20 is formed on the entire surface of the base member 10 (including the inner wall of the cylindrical through-hole) which has undergone the primer treatment. The resin layer 20 may be formed through, for example, lining, coating, painting (applying), sticking a resin sheet thereon, or a like technique. The thus-formed resin layer 20 has a thickness Tb (see FIG. 5) of 1 to 3 mm.

Subsequently, as shown in FIG. 6, the surface of the portion of the resin layer 20 covering the inner wall of the cylindrical through-hole provided in the base member 10 is machined for finishing so that the thickness of the portion is reduced from Tb to Ta. The machining may be performed through end-milling or a similar technique. Through machining, the forming surface P1 (i.e., cylinder inner wall surface) of the forming mold is completed. Since the machining is performed on the basis of the base member 10 having high rigidity, accuracy of working is enhanced as compared with the case where a forming mold is formed only of a resin layer. Thus, the form accuracy of the forming surface P1 is enhanced.

### (Action and Effects)

According to the method for producing a forming mold of the embodiment of the present invention, the forming surface P1 (i.e., cylinder inner wall surface) of the forming mold is formed from the resin layer 20 through machining. Therefore, the forming surface P1 has a form accuracy as high as that attained by a forming surface of a forming mold produced through machining without employing a resin layer. That is, the forming mold in which the forming surface P1 of the resin layer 20 has high form accuracy can be produced.

In addition, in the forming mold, the resin layer 20 is formed on the surface of the base member 10 having a rigidity higher than that of the resin layer 20. Therefore, as compared with a forming mold formed of only a resin layer, deformation of the resin layer is prevented, whereby the form accuracy of the forming surface made of the resin layer 20 can be further enhanced. Furthermore, the surface of the resin layer 20 which surface has a sufficient thickness Tb of 1 to 3 mm (i.e., 1 mm or more) is machined, to thereby form the forming surface P1. Thus, relatively large machining allowance (i.e., the thickness of a portion to be removed through machining, specifically Tb−Ta) can be ensured. As a result, even when the forming surface is the surface of the inner wall of a sufficiently elongated (with a sufficiently high aspect ratio) through-hole, the form accuracy of the entire forming surface P1 can be enhanced.

Notably, no particular limitation is imposed on the present invention. Other than the aforementioned embodiment, various modifications may be employed, within the scope of the present invention. For example, in the above embodiment, the “forming surface” is the surface of the inner wall of the cylinder. However, no particular limitation is imposed on the shape of the “forming surface,” so long as the forming surface is the surface of the resin layer formed on the surface of the base member, and the forming surface is finished through machining.

In the above embodiment, only a portion of the surface of the resin layer formed on the base member (i.e., inner wall surface of the cylinder) is provided to serve as a forming surface. However, alternatively, the entire surface of the resin layer formed on the base member may serve as a forming surface. In any case, the entire surface of the resin layer which surface serves as a forming surface is finished (completed) through machining.

1. A method for producing a forming mold comprising a base member, and a resin layer formed on the base member, wherein the resin layer has a surface serving as a forming surface, and the base member has a rigidity higher than that of the resin layer, which method comprises:
a forming step of forming on the base member a resin layer having a thickness of 1 mm or more, and
a machining step of machining the surface of the formed resin layer, to thereby form the forming surface.

2. A forming mold production method according to claim 1, wherein the forming surface formed through machining has a 10-point average roughness (Rz JIS) of 20 μm or less.

3. A forming mold production method according to claim 2, wherein the forming surface formed through machining has a contact angle with respect to water of 60° or more.

4. A forming mold production method according to claim 1, wherein the resin layer is formed from a fluorine compound as a material.

5. A forming mold production method according to claim 4, wherein the base member is formed from a metal as a material.

6. A forming mold production method according to claim 2, wherein the resin layer is formed from a fluorine compound as a material.

7. A forming mold production method according to claim 6, wherein the base member is formed from a metal as a material.

8. A forming mold production method according to claim 3, wherein the resin layer is formed from a fluorine compound as a material.

9. A forming mold production method according to claim 8, wherein the base member is formed from a metal as a material.
